(19) United States
(12) Patent Application Publication
(10) Pub. No.: US 2007/0039503 A1
(43) Pub. Date: Feb. 22, 2007

(54) Method to facilitate provision of an energizable design image

(76) Inventors: Tomasz Klosowiak, Glenview, IL (US); Krishna Kalyanasundaram, Elmhurst, IL (US); Jie Zhang, Buffalo Grove, IL (US); Daniel R. Gamota, Palatine, IL (US); Krishna D. Jonnalagadda, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/207,687

(22) Filed: Aug. 18, 2005

(51) Int. Cl. B41F 33/00

(52) U.S. Cl. 101/483

(57) ABSTRACT

An energizable design image portion of a provided design pattern (101) is printed (103) on a provided substrate (101) using a functional ink comprised of at least one energy emissive material. A passive design image portion of that design pattern is then also printed (104) on that substrate using at least one graphic arts ink. In a preferred embodiment this process (100) further provides for printing (105) electrically conductive electrodes on the substrate to permit selective energization of the energy emissive material to thereby induce illumination of the energizable design image portion of the design pattern.

### RELATED APPLICATIONS

This application is related to an application bearing attorney's docket number CML02309T (85065), entitled ENERGIZABLE DESIGN IMAGE APPARATUS and filed on even date herewith, the contents of which are incorporated herein by this reference.

### TECHNICAL FIELD

This invention relates generally to images and more particularly to printed images.

### BACKGROUND

Printing comprises a generally well understood area of endeavor and typically serves to produce images comprising artistic and/or informational content for viewing by an interested observer. Various printing techniques are known and various substrates exist to be printed upon. Graphic arts inks also exist in great variety and profusion, offering a wide range of colors, opacity, drying times, and adherent tendencies.

In recent times printing techniques have also been proposed for use in producing functional electrical and electronic circuits. In particular, recent ability to print active electric circuit elements such as transistors using functional inks that are, for example, electrically conductive or semiconductive has fostered considerable interest in this approach to producing known circuits in a new way.

To a large extent, however, the printing of traditional visually-perceptible content and the printing of active electrical circuitry has been viewed as two distinct fields of endeavor with only incidental overlap apart from the potential for similar ink application techniques to be employed for either.

### BRIEF DESCRIPTION OF THE DRAWINGS

The above needs are at least partially met through provision of the method to facilitate provision of an energizable design image described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a block diagram as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a substrate and at least one design pattern. In a preferred approach at least one graphic arts ink is used to print a passive design image portion of the design pattern on the substrate while a functional ink (comprising, in a preferred approach, at least one energy emissive material) is employed to print an energizable design image portion of the design pattern on the substrate. The design pattern itself can comprise any combination of artistic and/or symbolic informational content. The substrate, in turn, can comprise essentially any suitable printing surface including both two dimensional and three dimensional surfaces.

This process accommodates a wide variety of printing processes including both contact and non-contact printing processes. In a preferred though optional approach the process further provides for the printing of electrically conductive electrodes on the surface to thereby facilitate an application of electrical potential to the energizable design image portion to effect its illumination.

So configured, relatively inexpensive printing processes and materials can serve to produce energizable images on commonly available surfaces such as posters, containers, stationary, and so forth. When energized, such images can complement and/or otherwise emphasize the passive design content as also appears on the substrate or can provide supplement artistic and/or informational content. As these teachings require relatively modest expense to effect, these processes are readily applicable for use with relatively short-term applications such as daily menus, weekly retail sales promotions, newspaper headlines, boxes for consumer commodities of various types, shipping containers, and any number of promotions-related applications, to name but a few.

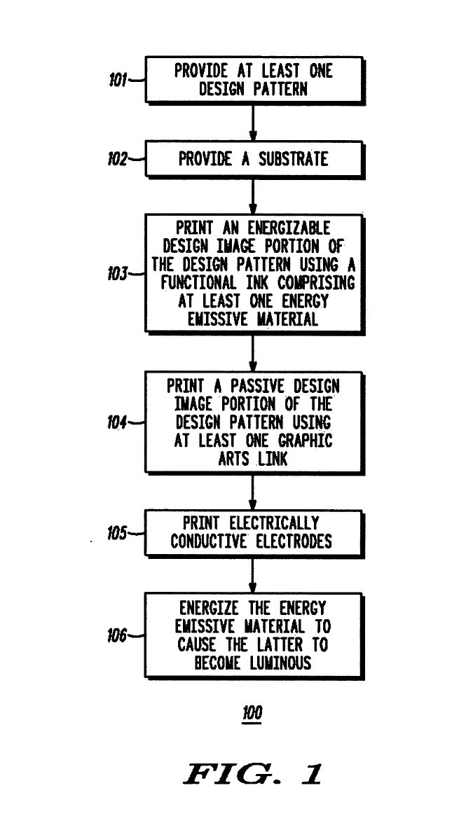

These and other benefits may become clearer upon making a thorough review and study of the following detailed description. Referring now to the drawings, and in particular to FIG. 1, an exemplary process 100 provides 101 for at least one design pattern. Design patterns in general are well known in the art. Those skilled in the art will understand that these teachings are compatible for use with essentially any and all design patterns including, but not limited to:
alphanumeric characters;
logos;
object depictions;
artistic renderings of images (where “artistic” is commonly understood to comprise that which relates to the conscious production or arrangement of forms in a manner that affects a sense of aesthetic value);
pictographs;
at least one pictogram; and
optical codes (such as bar codes and the like);
   to name but a few.

It will also be understood that such a design pattern can comprise any combination of mixed content. For example, it is specifically contemplated that a design pattern can comprise both artistic renderings (such as an image of an object of interest) and symbolic informational content (such as written text). It will also be understood by those skilled in the art that a plurality of such design patterns can be provided when and as desired.

Such design patterns can be provided via any appropriate means of delivery as may presently exist or as may be developed in the future. This can include hard copy renderings, digitally rendered and stored offerings, specific instructions which, when executed, yield the desired design pattern, and so forth.

This process 100 also provides for provision 102 of a substrate upon which the design pattern can be printed. Essentially any suitable printing medium can be employed with specific selections likely serving the specific needs and requirements of a given application. Examples include, but are not limited to, paper substrates (such as but not limited to paper, cardboard, paperboard, corrugated cardboard, and other cellulose pulp-based materials), polymer-based materials, woven material substrates (including but not limited to cloths of various types), and so forth. As will be shown below, this substrate can further comprise any of a wide variety of substantially two-dimensional surfaces (such as a sheet of material) or a three-dimensional surface (such as a container for an object or the object itself).

This process 100 then provides for printing 103 an energizable design image portion of the design pattern on the substrate using a functional ink comprising at least one energy emissive material. The energy emissive material is preferably one that is energizable by application of an electric field (as may be supplied, for example, by a battery, photovoltaics, fuel cell, alternating current based power source, or the like). Useful examples include, but are not limited to, functional inks comprised of a phosphor or organic light emitting diode materials. In general, any material suitable for placement as an ink and which is capable of selectively emitting light when energized by an electric field will likely suffice at least for some applications. Those skilled in the art will understand that printing of the energizable design image portion of the design pattern may also entail printing a dielectric layer in conjunction therewith (depending upon the particular material and technology employed for a given embodiment).

These teachings are not especially sensitive regarding use of any particular printing process and acceptable results are likely possible with any of a wide variety of such techniques. In general the energizable design image portion of the design pattern can be printed using any contact or non-contact printing process. Contact printing examples include, though are not limited to, screen printing processes, flexography printing processes, gravure printing processes, micro-contact printing process, and offset printing processes while non-contact printing examples include, though are not limited to, ink dispensing printing processes, ink jet printing processes, curtain coating printing processes and so forth.

In addition to printing the energizable design image portion of the design pattern this process 100 also provides for printing 104 a passive design image portion of the design pattern on the substrate using at least one graphic arts ink. “Passive,” of course, refers to the non-energizable nature of the graphic arts ink as versus the functional ink (or inks) employed to print the energizable design image portion and “graphic arts ink” will be understood to refer to inks as are ordinarily used in the graphic arts for traditional printing properties such as color, opacity, dispersability, drying time, and so forth.

These printing steps 103 and 104 may each comprise, in a specific application setting, a plurality of corresponding steps as when multiple functional inks and/or graphic arts inks are to be printed on a single substrate. Conversely, it may also be desirable in a given setting to combine both printing steps 103 and 104 in a single action such that both functional and graphic arts inks are printed on the substrate effectively at the same time and/or pursuant to a single printing action. Alternatively, of course, steps 103 and 104 may be reversed as well.

In order to facilitate selective energization of the energizable design image portion of the design pattern, it may be helpful to provide electrically conductive electrodes to facilitate application of an electric field. These electrodes can comprise non-printed elements if desired. For example, electrically conductive wires can be bonded (using, for example, an appropriate adhesive) to the substrate to be in electrical contact with the energizable design image portion of the design pattern. It is also possible, however, to optionally print 105 at least a portion of such electrodes on the substrate itself (using, for example, a functional ink that is comprised of electrically conductive material). This will typically entail printing the electrodes in electrical contact with the energizable design image portion of the design pattern.

Such electrodes can lead to an off-substrate power source when appropriate. For example, such printed electrodes can lead to a portion of the substrate where electrically conductive clips are used to couple a battery, fuel cell, alternating-current based power source, or photovoltaics to the electrodes and hence to the energizable design image portion of the design pattern. To the extent that a power source can itself be disposed as a part of the substrate, of course, it would also be possible to couple that power source to the energizable design image portion of the design pattern through use of such electrodes.

So configured, this process 100 then further, optionally but preferably, supports energization 106 of the energy emissive material (for example, by applying electricity to the display electrodes as may also be printed on the substrate as described above) to thereby cause the energizable design image portion of the design pattern as is printed on the substrate to become luminous (i.e., to emit light). This, in turn, greatly expands artistic opportunities as well as informational conveying opportunities as compared to past practices. Such illumination can serve simply to attract one's attention, to convey information not otherwise conveyed, or even to enrich and expand the expressive palate available to the designer.

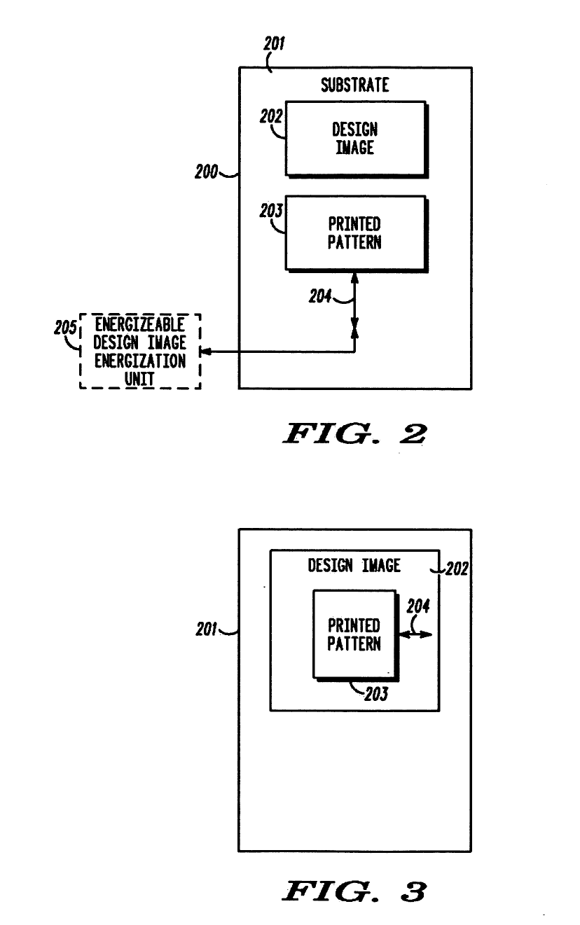

Those skilled in the art will appreciate that the above-described processes are readily carried out using any of a wide variety of available and/or readily configured materials and/or platforms. Referring now to FIG. 2, a platform illustrative of these teachings will be provided. Those skilled in the art will recognize that FIG. 2 comprises a block diagram logical view of an illustrative embodiment as versus an explicit physical view of a particular embodiment.

An apparatus 200 comprising at least a substrate 201 has a design image 202 and a printed pattern 203 printed thereon. The substrate 201 can comprise any suitable printing medium including, but not limited to, paper substrate material, woven material, a polymer material, and so forth. The substrate 201 itself can comprise, for example, a poster, stationary, a menu, a theater program, a map, an announcement, a page from a larger publication such as a book, magazine, or newspaper, an envelope, an item of clothing, or such other surface as may accommodate the specific needs or requirements of a given application.

The design image 202 portion of the apparatus 200 can be formed using at least one graphic arts ink and can comprise at least one of an artistic rendering and/or symbolic informational content. This design image 202 can be relatively simple in form or complex in nature and can be monochromatic or polychromatic as desired.

The printed pattern 203 preferably comprises an energizable design image formed using a functional ink comprising at least one selectively energy emissive material. It is this portion of the apparatus 200 that can be selectively self-illuminated as described above. This printed pattern 203 can comprise essentially any artistic rendering and/or symbolic informational content as well as only some portion thereof. The printed pattern 203 can be visually separate and distinct from the design image 202 as is suggested by the depiction provided in FIG. 2 or can be partially or wholly inter-combined with the latter as is suggested by the depiction provided in FIG. 3 (as when the energizable printed pattern comprises an integral aesthetic component of the design image itself).

As noted above, the design image and the printed pattern can both be printed using any selected printing process including both contact and non-contact printing processes. As also mentioned above, it may be preferred to also provide an energizable design image energization interface 204 to facilitate selective energization of the printed pattern. Depending upon the application context, this energization interface 204 can comprise a fully printed interface such as display electrodes (using, for example, electrically conductive functional ink) or can comprise a partially or wholly unprinted electrically conductive element (such as a discrete electrically conductive wire).

As already noted, this energization interface 204 can comprise one or more electrical conductors that couple the energizable printed pattern to a source of power. If desired, this interface 204 can comprise additional functionality and/or structure. For example, if desired, this interface 204 can comprise a wireless interface (wherein the wireless interface further serves to control the provision of energy to the printed pattern as a function, at least in part, of remote control signals as are received via the wireless interface) such as, for example, a wireless local area network interface, a radio frequency identifier interface, an optical interface, or the like. Wireless interfaces are generally well understood in the art as are the communication protocols used therewith. Accordingly additional elaboration regarding such interfaces will not be provided here for the sake of brevity and clarity.

As noted, in a typical embodiment the printed pattern 203 will require a source of energy to become energized and hence luminous. An optional energizable design image energization unit 205 can operably couple to the printed pattern 203 via the energization interface 204 to effect such performance. This energizable design image energization unit 205 can comprise, for example, a suitable power source coupled, if desired, with switching capability to control the provision of that power to the printed pattern 203. This switching capability can be configured and arranged as desired to suit the needs and requirements of a given setting. For example, this switching capability can be operable by a human operator through manipulation of a physical interface such as a switch, button, potentiometer, or the like. As another example, this switching capability can be responsive to a fully or partially automated control scheme. So configured, an illuminatable printed pattern 203 is selectively rendered luminous via the provision and use of an energizable design image energization unit 205 wherein the latter may comprise an integral part of the substrate 201 (as when the energization unit 205 itself comprises, for example, a printed battery) or may comprise a stand-alone component of the overall apparatus 200.

As noted earlier, the artistic and/or informational content of the design image 202 itself can be comprised of multiple components. Similarly, and referring now to FIG. 4, the printed pattern can comprise a plurality of printed patterns 401 and 403 wherein each such pattern is separately energizable via, for example, a discrete and separate energization interface 402 and 404. So configured, these printed patterns can be illuminated together or can be illuminated on an individually selective basis.

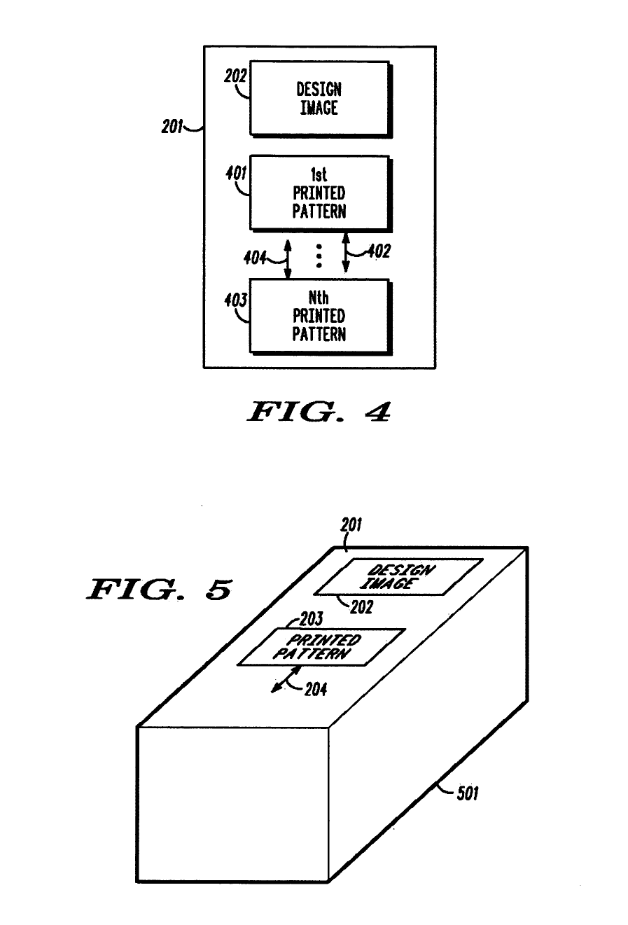

Referring to FIG. 5, and also as noted earlier, the substrate 201 itself can comprise a part of (or otherwise be combined with) a three-dimensional object such as, in this illustration, a container 501 for an object (such as a consumer commodity or package). For example, the substrate 201 can comprise a forward-facing (i.e., an outward-facing) surface of the container or object.

It will therefore be seen and understood that these teachings facilitate the provision of an object (such as a two or three-dimensional object) having a surface with a printed rendering disposed thereon. That printed rendering itself will preferably comprise both a first portion that is formed of at least one graphic arts ink and a second portion that is formed of at least one functional ink comprising at least one energy emissive material. In a preferred approach that printing further comprises an energization interface that is operably coupled to the second portion and that is itself comprised of at least one functional ink that comprises an electrically conductive material. These embodiments can be comprised of relatively inexpensive materials and achieved through use of relatively inexpensive and uncomplicated processes. Notwithstanding this relative ease of implementation and low cost of the resultant apparatus offers significant improvement with respect to increasing available artistic and informational opportunities.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing at least one design pattern;
providing a substrate;
printing an energizable design image portion of the design pattern on the substrate using a functional ink comprising at least one energy emissive material;
printing a passive design image portion of the design pattern on the substrate using at least one graphic arts ink.

2. The method of claim 1 wherein the design pattern comprises at least one of:
at least one alphanumeric character;
at least one logo;
at least one depiction of an object;
at least one artistic rendering of an image;
at least one pictograph;
at least one pictogram;
at least one optical code.

3. The method of claim 1 wherein the substrate comprises a paper substrate.

4. The method of claim 3 wherein the paper substrate comprises at least one of:
paper;
cardboard;
paperboard;
corrugated cardboard.

5. The method of claim 1 wherein the substrate comprises at least one of:
a polymer;
a woven material substrate.

6. The method of claim 1 wherein the energy emissive material is energizable by application of an electric field.

7. The method of claim 1 wherein printing an energizable design image portion of the design pattern on the substrate comprises printing using at least one of:
a contact printing process;
a non-contact printing process.

8. The method of claim 7 wherein the contact printing process comprises at least one of:
a screen printing process;
a flexography printing process;
a gravure printing process;
an offset printing process.

9. The method of claim 7 wherein the non-contact printing process comprises at least one of:
an ink dispensing printing process;
an ink jet printing process;
a curtain coating printing process.

10. The method of claim 1 further comprising:
printing electrically conductive electrodes on the substrate.

11. The method of claim 10 wherein printing electrically conductive electrodes comprises printing electrically conductive electrodes in electrical contact with the energizable design image portion of the design pattern.

12. The method of claim 11 wherein printing electrically conductive electrodes in electrical contact with the energizable design image portion of the design pattern comprises printing the electrically conductive electrodes using at least one functional ink comprising an electrically conductive material.

13. The method of claim 10 wherein printing electrically conductive electrodes on the substrate comprises printing the electrically conductive electrodes in electrical contact with a wireless interface.

14. The method of claim 1 further comprising:
energizing the energy emissive material to thereby cause the energizable design image portion of the design pattern as is printed on the substrate to become luminous.

15. The method of claim 14 wherein energizing the energy emissive material comprises applying electricity to display electrodes as are also printed on the substrate.

16. The method of claim 1 wherein the design pattern comprises at least one of an artistic rendering and symbolic informational content.

17. A method of forming a substrate having at least one selectively luminous design image, comprising:
providing a substrate;
forming a design image on the substrate by:
printing a first portion of the design image using a functional ink comprising at least one energy emissive material;
printing a second portion of the design image using at least one graphic arts ink;
using at least one electrically conductive functional ink to print display electrodes on the substrate to thereby facilitate selective energization of the energy emissive material as comprises the design image.

18. The method of claim 17 wherein the substrate comprises at least one of:
a cellulose pulp-based material;
a polymer material;
a woven material.

19. The method of claim 17 wherein forming a design image further comprises forming a plurality of design images on the substrate using a functional ink comprising an energy emissive material.
